(19) United States
(12) Patent Application Publication
(10) Pub. No.: US 2009/0171767 A1
(43) Pub. Date: Jul. 2, 2009

(54) RESOURCE EFFICIENT RESEARCH DATA GATHERING USING PORTABLE MONITORING DEVICES

(75) Inventor: Ronald S. Kolessar, Elkridge, MD (US)

Correspondence Address: KATTEN MUCHIN ROSENMAN LLP / ARBITRON INC.;(C/O PATENT ADMINISTRATOR), 2900 K STREET NW, SUITE 200, WASHINGTON, DC, 20007-5118, US

(73) Assignee: Arbitron, Inc., Columbia, MD (US)

(21) Appl. No.: 12/165,406

(22) Filed: Jun. 30, 2008

Related U.S. Application Data
(60) Provisional application No. 60/947,288, filed on Jun. 29, 2007.

(51) Int. Cl. G06Q 10/00

(52) U.S. Cl. 705/10; 705/7

(57) ABSTRACT

Methods and systems are provided for carrying out a research operation in which each of a plurality of panelists carries a portable research data gathering device. Each of the portable research data gathering devices is configured to gather research data only during a time period or time periods of a monitoring day of the research operation having a total duration which is less than the duration of the monitoring day. Methods and systems are also provided for setting up and/or managing such a research operation.

### BACKGROUND

Methods and systems for conducting research operations using portable monitoring devices in a resource efficient manner are disclosed.

Research operations are conducted by establishing a panel of participants, often referred to as panelists. In some research operations, the panelists are provided with portable monitoring devices to gather research data. In other research operations the panelists' own portable devices are employed to gather research data. In either case, the panelists are instructed to carry the portable devices with them during the day for gathering research data, such as data indicating exposure to media.

Such portable devices rely on internal power supplies, such as batteries, when they are being carried about Especially where the portable devices are used to carry out multiple operations, such as wireless communications and running various applications, the internal power supply may become depleted prematurely.

### DISCLOSURE

For this application, the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of corresponding information in a different physical form or forms.

The terms “media data” and “media” as used herein mean data which is widely accessible, whether over-the-air, or via cable, satellite, network, internetwork (including the Internet), print, displayed, distributed on storage media, or by any other means or technique and that is humanly perceptible, with or without the aid of any machine or device, and without regard to the form or content of such data, and including but not limited to audio, video, audio/video, text, images, animations, databases, broadcasts, displays (including but not limited to video displays, posters and billboards), signs, signals, web pages, print media and streaming media data.

The term “research data” as used herein means data comprising (1) data concerning usage of media data, (2) data concerning exposure to media data, and/or (3) market research data.

The term “research operation” as used herein means an operation comprising gathering, storing and/or communicating research data.

The term “presentation data” as used herein means media data or content other than media data to be presented to a user.

The term “ancillary code” as used herein means data encoded in, added to, combined with or embedded in media data or content other than media data to provide information identifying, describing and/or characterizing the media data or content other than media data, and/or other information useful as research data.

The terms “reading” and “read” as used herein mean a process or processes that serve to recover research data that has been added to, encoded in, combined with or embedded in, media data.

The term “day” as used herein means a day of the week or an equivalent time period.

The term “monitoring day” as used herein means an entire time period of a day, or all time periods of a day taken collectively, as the case may be, during which research data is collected by portable monitors pursuant to a research operation. Depending on the parameters selected for a given research operation, a monitoring day can be (a) a single span of time during a day which is less than the entire monitoring day (such as a twelve hour time period, an eighteen hour time period or other), (b) multiple time periods of a day, or (c) an entire day.

The term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a report, a list or in any other form.

The term “network” as used herein includes both networks and internetworks of all kinds, including the Internet, and is not limited to any particular network or internetwork.

The terms “first”, “second”, “primary” and “secondary” are used to distinguish one element, set, data, object, step, process, function, activity or thing from another, and are not used to designate relative position, or arrangement in time or relative importance, unless otherwise stated explicitly.

The terms “coupled”, “coupled to”, and “coupled with” as used herein each mean a relationship between or among two or more devices, apparatus, files, circuits, elements, functions, operations, processes, programs, media, components, networks, systems, subsystems, and/or means, constituting any one or more of (a) a connection, whether direct or through one or more other devices, apparatus, files, circuits, elements, functions, operations, processes, programs, media, components, networks, systems, subsystems, or means, (b) a communications relationship, whether direct or through one or more other devices, apparatus, files, circuits, elements, functions, operations, processes, programs, media, components, networks, systems, subsystems, or means, and/or (c) a functional relationship in which the operation of any one or more devices, apparatus, files, circuits, elements, functions, operations, processes, programs, media, components, networks, systems, subsystems, or means depends, in whole or in part, on the operation of any one or more others thereof.

The terms “communicate,” and “communicating” and as used herein include both conveying data from a source to a destination, and delivering data to a communications medium, system, channel, network, device, wire, cable, fiber, circuit and/or link to be conveyed to a destination and the term “communication” as used herein means data so conveyed or delivered. The term “communications” as used herein includes one or more of a communications medium, system, channel, network, device, wire, cable, fiber, circuit and link.

The term “processor” as used herein means processing devices, apparatus, programs, circuits, components, systems and subsystems, whether implemented in hardware, software or both, and whether or not programmable. The term “processor” as used herein includes, but is not limited to one or more computers, hardwired circuits, signal modifying devices and systems, devices and machines for controlling systems, central processing units, programmable devices and systems, field programmable gate arrays, application specific integrated circuits, systems on a chip, systems comprised of discrete elements and/or circuits, state machines, virtual machines, data processors, processing facilities and combinations of any of the foregoing.

The terms “storage” and “data storage” as used herein mean one or more data storage devices, apparatus, programs, circuits, components, systems, subsystems, locations and storage media serving to retain data, whether on a temporary or permanent basis, and to provide such retained data.

The terms “panelist,” “panel member,” “respondent” and “participant” are interchangeably used herein to refer to a person who is, knowingly or unknowingly, participating in an operation to gather research data.

The term “household” as used herein is to be broadly construed to include family members, a family living at the same residence, a group of persons related or unrelated to one another living at the same residence, and a group of persons (of which the total number of unrelated persons does not exceed a predetermined number) living within a common facility, such as a fraternity house, an apartment or other similar structure or arrangement, as well as such common residence or facility.

The term “research device” as used herein shall mean (1) a portable user appliance configured or otherwise enabled to gather, store and/or communicate research data, or to cooperate with other devices to gather, store and/or communicate research data, and/or (2) a research data gathering, storing and/or communicating device.

The term “portable user appliance” (also referred to herein, for convenience, by the abbreviation “PUA”) as used herein means an electrical or non-electrical device capable of being carried by or on the person of a user or capable of being disposed on or in, or held by, a physical object (e.g., attaché, purse) capable of being carried by or on the user, and having at least one function of primary benefit to such user, including without limitation, a cellular telephone, a personal digital assistant (“PDA”), a Blackberry device, a radio, a television, a game system (e.g., a Gameboy® device), a notebook computer, a laptop computer, a GPS device, a personal audio device (such as an MP3 player or an iPod® device), an iPhone™ device, a DVD player, a two-way radio, a personal communications device, a telematics device, a remote control device, a wireless headset, a wristwatch, a portable data storage device (e.g., Thumb™ drive), a camera, a recorder, a keyless entry device, a ring, a comb, a pen, a pencil, a notebook, a wallet, a tool, a flashlight, an implement, a pair of glasses, an article of clothing, a belt, a belt buckle, a fob, an article of jewelry, an ornamental article, a shoe or other foot garment (e.g., sandals), a jacket, and a hat, as well as any devices combining any of the foregoing or their functions.

A method carried out in a research operation in which each of a plurality of panelists carries a portable research data gathering device comprises selecting respective ones of the portable research data gathering devices and configuring each of the selected portable research data gathering devices to gather research data only during a time period or time periods of a monitoring day of the research operation having a total duration which is less than the duration of the monitoring day.

A system for setting up and/or managing a research operation in which each of a plurality of panelists carries a portable research data gathering device comprises a processor operative to select respective ones of the portable research data gathering devices, the processor being operative to configure each of the selected portable research data gathering devices to gather research data only during a time period or time periods of a monitoring day of the research operation having a total duration which is less than the duration of the monitoring day.

A system for gathering research data in a research operation comprises a plurality of portable research data gathering devices each capable of being carried by a panelist, each of the portable research data gathering devices being configured to gather research data only during a time period or time periods of a monitoring day of the research operation having a total duration which is less than the duration of the monitoring day.

A method for gathering research data in a research operation comprises gathering research data using a plurality of portable research devices each carried by a respective one of a plurality of panelists, each of the research devices being configured to gather research data only during a time period or time periods of a monitoring day of the research operation having a total duration which is less than the duration of the monitoring day.

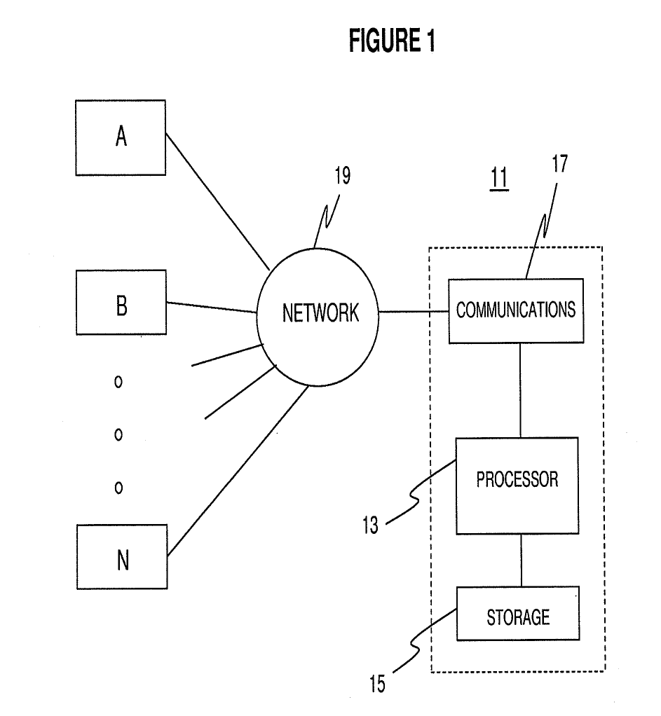

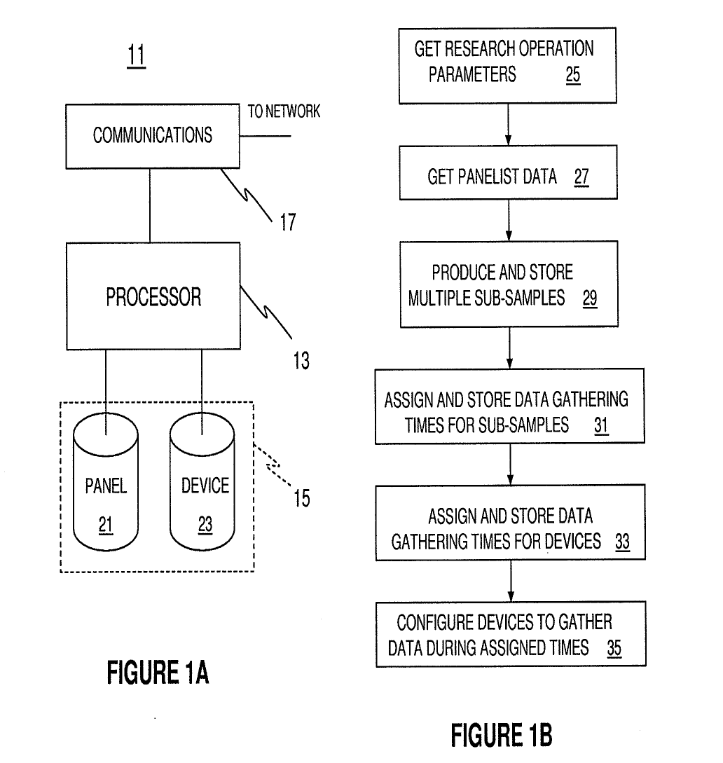

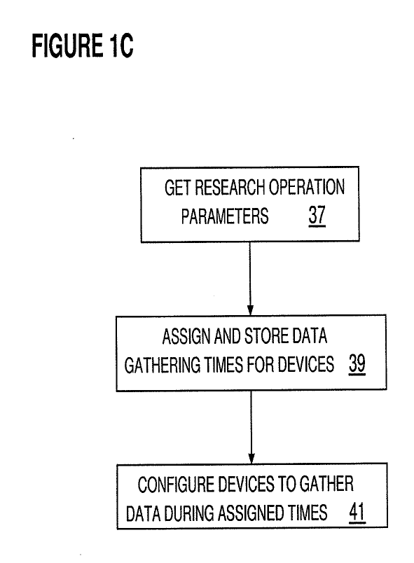

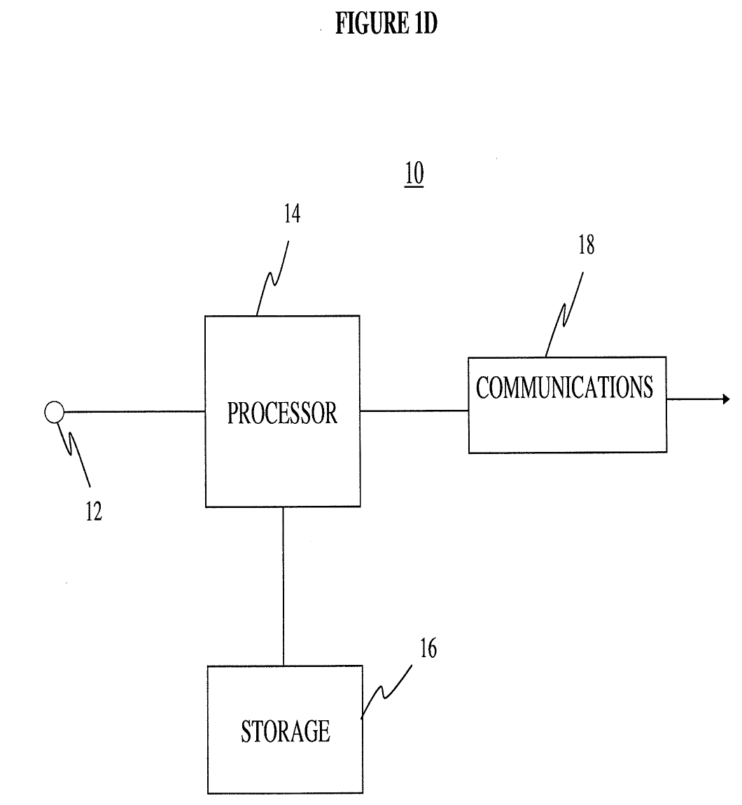

FIG. 1 illustrates an embodiment of a system for setting up and/or maintaining a system for gathering research data with the use of portable monitors, as well as an embodiment of such a system for gathering research data;

FIG. 1A illustrates additional features of the embodiment of the system for setting up and maintaining such a research data gathering system illustrated in FIG. 1;

FIG. 1B illustrates certain embodiments of a process for configuring multiple portable research data gathering devices using the embodiment of FIG. 1A;

FIG. 1C illustrates a further embodiments of a process for configuring multiple portable research data gathering devices using the embodiment of FIG. 1A;

FIG. 1D illustrates certain embodiments of portable research data gathering devices in block form;

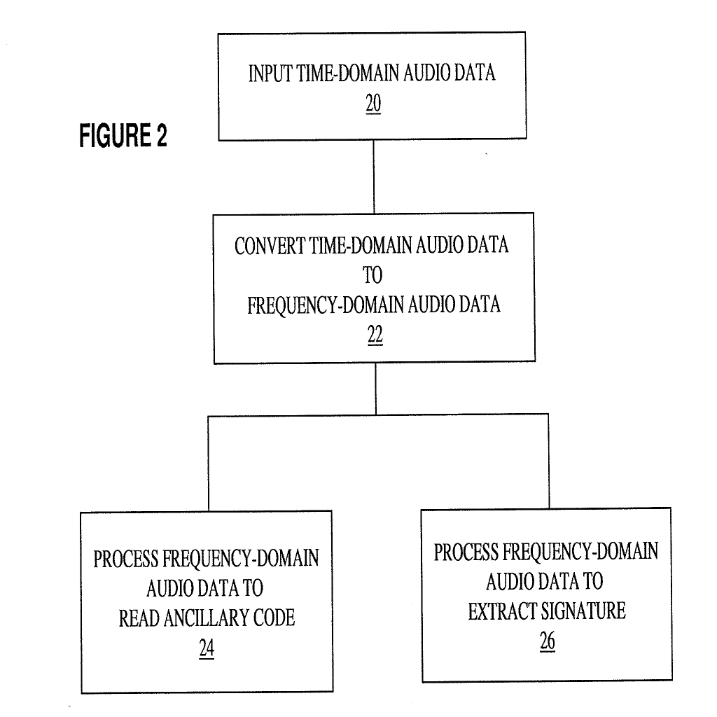

FIG. 2 illustrates embodiments of certain processes for operating the device of FIG. 1D;

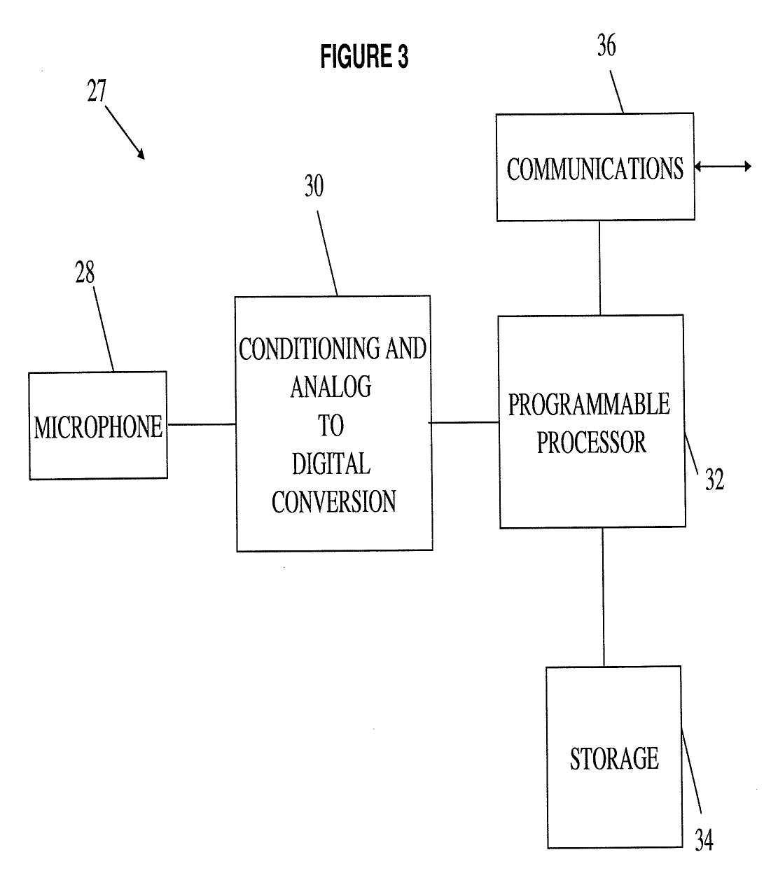

FIG. 3 illustrates certain embodiments of portable research data gathering devices in block form;

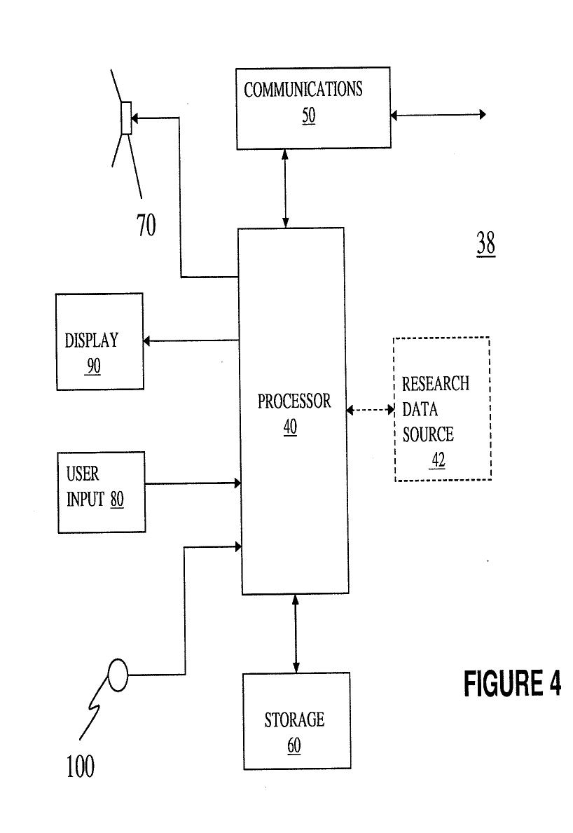

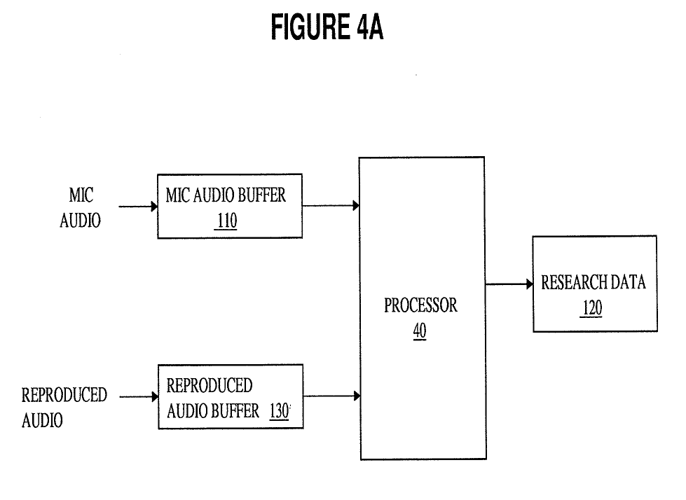

FIG. 4 illustrates certain embodiments of cellular telephones in block form adapted for gathering research data;

FIG. 4A illustrates certain data gathering processes used in gathering research data using the cellular telephone of FIG. 4;

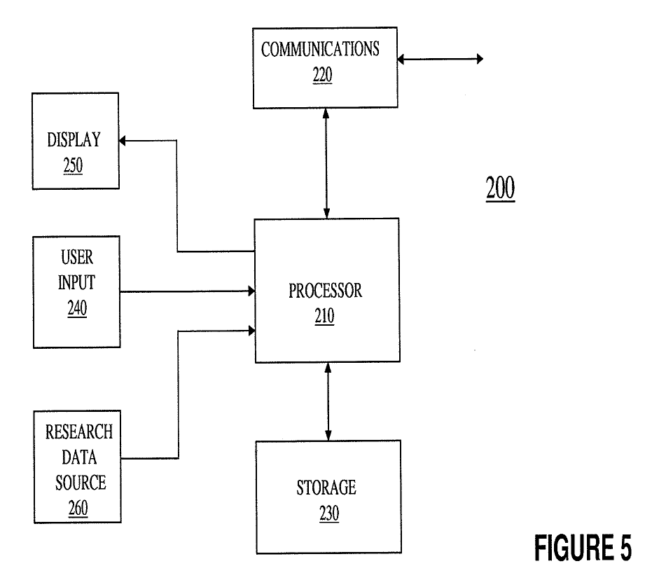

FIG. 5 illustrates certain embodiments of personal digital assistants (PDA's) in block form adapted for gathering research data;

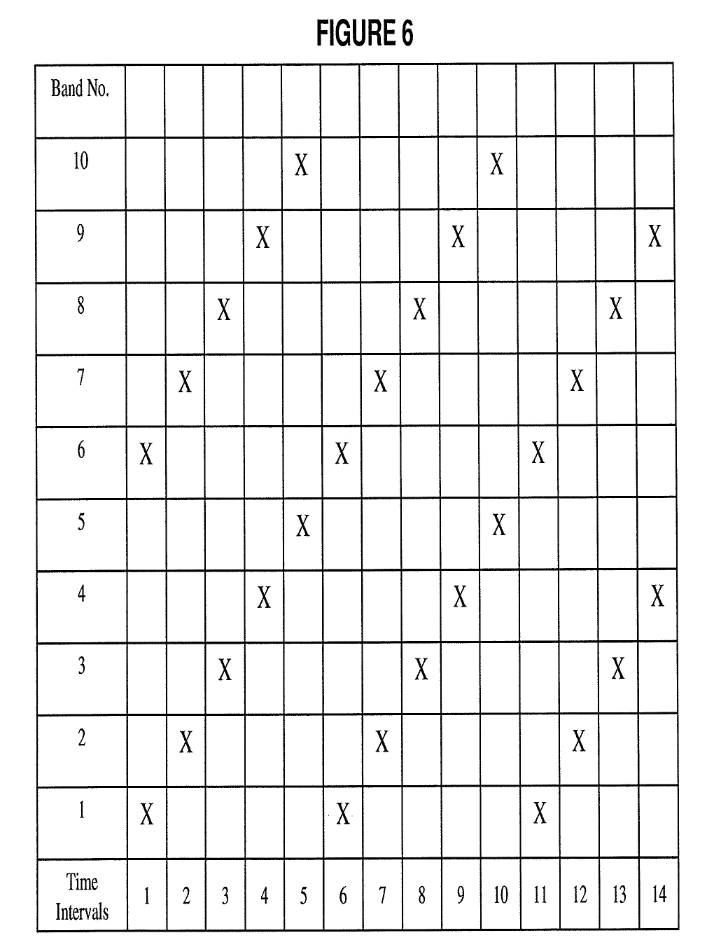

FIG. 6 illustrates embodiments of certain processes for extracting signatures from audio data implemented in various embodiments of portable research data gathering devices.

The disclosed methods and systems, as well as particular features and advantages of various embodiments thereof will become more apparent from the following detailed description considered with reference to the accompanying drawings in which the same elements depicted in different drawing figures are assigned the same reference numerals.

Various data gathering techniques carried out by portable devices are suitable. For example, data concerning exposure to television, radio, web pages, streaming media, audio and/or video downloads, media recorded on storage devices, print media, outdoor media, games, exposure to products, presence and movements in commercial establishments, location relative to places of interest, and panelist activities, are gathered by various portable devices utilizing a variety of techniques. Data can be gathered by receiving acoustic energy, optical energy (e.g., infrared light, visible light and shorter wavelengths), radio frequency energy, electrical energy or fields, mechanical energy and magnetic fields. Such data gathering can be carried out passively, or with the panelist's active participation (such as operating manual inputs or providing a verbal response).

FIG. 1 illustrates a system 11 for setting up and/or managing a research operation in which each of N panelists carries a respective portable research data gathering device A, B, . . . , N, where N is a natural number greater than 1. Devices A, B, . . . , N are selected to have a size and shape to permit the panelists to carry them about conveniently at times during the day for gathering research data pursuant to the research operation, the research data being any one or more of the kinds described in this application and/or other kinds of data useful in research operations of various kinds. In certain embodiments, devices A, B, . . . , N all are structurally identical and operate in a common manner to gather data, while in other embodiments, certain ones of the devices A, B, . . . , N differ from others of the devices structurally and/or operationally. For example, in certain research operations, PUA's of the panelists, such as cellular telephones, personal digital assistants and/or personal audio and/or video devices are configured to gather research data, with or without additional software and/or hardware enabling the data to be gathered, stored and/or communicated. In certain research operations, portable devices dedicated to gathering research data are provided to the panelists by a research organization. For example, Arbitron Inc. provides panelists with PPM™ decoders which the panelists carry about to gather data concerning the exposure of the panelists to media data.

System 11 comprises a processor 13, storage 15 coupled with processor 13 and communications 17 coupled with processor 13. The system 11 communicates with the portable devices A, B, . . . , N via a network 19. In certain embodiments, network 19 comprises a wide area network, such as a public switched telephone network (PSTN), the Internet, a dedicated network and/or a private network. Such embodiments are useful, for example, for communicating data from system 11 to the devices A, B, . . . , N after they have been provided to panelists at various locations throughout a market or multiple markets for gathering data. In certain embodiments, network 19 comprises a local area network, such as a network enabling hosts in one or more facilities in a relatively small area to communicate data. Such embodiments are useful, for example, where the portable devices A, B, . . . , N are configured for gathering data before they are provided to panelists for this purpose. In certain embodiments, network 19 comprises both one or more wide area networks and one or more local area networks. In certain embodiments, the portable devices A, B, . . . , N are configured without the use of a network, for example where the devices are configured as manufactured or subsequently modified to configure or reconfigure them, for example, by loading new firmware from a system directly connected to each of the devices individually or in groups of devices, or by installing replacement or additional components in the devices. In such embodiments, system 11 stores data indicating how the various devices A, B, . . . , N are to be configured with is then used directly or indirectly to configure devices A, B, . . . , N.

Storage 15 stores such configuration data for use by system 11. The configuration data includes data identifying each of the devices A, B, . . . , N associated with data indicating the time period or time periods of a monitoring day of a research operation during which the respective device A, B, . . . , N will gather research data, wherein such time period or time periods have a total duration which is less than the duration of the monitoring day. As an illustrative example, for one of the devices A, B, . . . , N, the configuration data will configure such device to gather data only during a two hour time period from 6:00 AM to 8:00 AM, while for another one of the devices A, B, . . . , N, the configuration data will configure such device to gather data only during a two hour time period from 8:00 AM to 10:00 AM. For a further one of the devices A, B, . . . , N, the configuration data will configure such device to gather data only during a two hour time period from 10:00 AM to Noon, while still others will be configured by the configuration data to gather data for still other two hour time periods, so that collectively, the devices A, B, . . . , N will collect research data throughout the monitoring day. In certain embodiments, certain ones or all of the device A, B, . . . , N will each be configured to gather data during multiple time periods within the monitoring day for a total duration which is less than the duration of the entire monitoring day. In certain embodiments, the time periods assigned to the various devices a, B, . . . , N overlap, while in others, the time periods do not overlap. In certain embodiments, the time periods assigned to certain ones of the devices A, B, . . . , N have different durations, for example, where the power capacity and/or power requirements of the devices differ, and/or where the storage, processing and/or communications capabilities of the devices vary from device to device. In certain embodiments, the time periods assigned to certain ones of the devices A, B, . . . , N are based on the corresponding panelist's device usage patterns, device battery levels, typical panelist behavior patterns that influence battery consumption, typical times of media exposure, and the like. In certain embodiments, the time period or periods assigned to some or all of the devices A, B, . . . , N vary from monitoring day to monitoring day, while in other embodiments the time period or time periods assigned to some or all of the devices A, B, . . . , N are the same for each monitoring day. In certain ones of the embodiments where the time period or periods assigned to some or all of the devices A, B, . . . , N vary from monitoring day to monitoring day, the time period or periods assigned to a given one of the devices will vary from day to day in a periodically repeating pattern, while in certain ones of such embodiments, the time period or periods assigned to a given one of the devices will vary from day to day in a randomized manner. In certain embodiments where two or more kinds of research data are gathered by certain ones or all of the devices A, B, . . . , N or where such devices utilize multiple research data gathering modes or capabilities, the configuration data for such devices assign differing data gathering time periods to some or all of the devices for gathering different types of research data, for operating in different data gathering modes and/or for utilizing different data gathering capabilities.

In the embodiment of FIG. 1, processor 13 reads the configuration data from storage 15 and, for each of the devices prepares a message for communication to some or all of the devices A, B, . . . , N which, when received by each device, will instruct it to store its respective configuration data as appropriate to control the device to gather research data only during the time period or time periods during each monitoring day as determined by the configuration data. Processor 13 then controls communications 17 to communicate the messages to their respective devices A, B, . . . , N via network 19.

FIG. 1A illustrates certain embodiments of system 11 wherein storage 15 comprises a panel database 21 storing data identifying the various panelists participating in the research operation in association with panelist characteristic data representing selected characteristics of each panelist, such as age, sex, race, income, location of household, education level, consumption habits and other personal habits, brand preferences, preferred recreational activities, political affiliations and opinions, religious beliefs, nature of commute to work, occupation, affiliations with fraternal, charitable and social organizations, and the like. Storage 15 further comprises a device database 23 storing data identifying each of the portable research data gathering devices A, B, . . . , N in association with the configuration data for each device along with other data characterizing such device, such as the type of device (e.g., dedicated data gathering device, cellular telephone, PDA, etc.), its make and model ID, its operating system (if any), and data indicating its power capacity, processing power, storage capacity and/or communications capabilities, as the case may be.

FIG. 1B illustrates a process for producing the configuration data for the devices A, B, . . . , N based on the panelist characteristic data of the panelists A, B, . . . , N in a manner that is designed to ensure a statistically valid sample of panelists for each of the time periods during which research data is gathered. That is, those of the devices A, B, . . . , N which gather data during each respective time period correspond to a group of panelists having a predetermined profile of panelist characteristic data that fairly represents a population from which the plurality of panelists are selected. While each of the devices A, B, . . . , N only gathers research data during a time period or time periods that total less than the entire monitoring day, collectively the devices A, B, . . . , N gather data throughout the monitoring day.

In the process, processor 13 accesses 25 research operation parameter data from a database (not shown for purposes of simplicity and clarity) which indicate the composition in terms of personal characteristics, required of a valid sample of the population for which the research operation is being conducted (for example, the population of a geographically defined market area) and its necessary size, as well as data prescribing the data gathering time periods. In certain embodiments, the research operation parameter data prescribes the number and/or proportions of the devices A, B, . . . , N to be configured to gather research data in each data gathering time period. Processor 13 also accesses 27 panelist data from the database 21 indicating the identities of the panelists in the panel and including their panelist characteristic data.

Based on the panelist data and the research operation parameter data, processor 13 produces a plurality of sub-samples each including respective ones of the panelists, each balanced so that the panelist characteristic data of the sub-sample collectively matches the characteristics of the population sampled within predetermined tolerances and of sufficient size to conform to the research operation parameter data. In certain embodiments, the sub-samples are selected to have the same or substantially the same numbers of panelists, while in others, some or all of the sub-samples are selected to have substantially different number of panelists than other sub-samples. As an illustrative embodiment, it may be desired to gather relatively larger amounts of data during certain times of the monitoring day, such as during morning and evening drive times where data concerning exposure to radio media is gathered with the use of the devices A, B, . . . , N, in which case the sub-samples chosen for gathering such data during these times may be relatively larger than sub-samples chosen for other time periods. In certain embodiments, processor 13 produces the sub-samples by selecting panelist data in a randomized manner from database 21 until a sufficient number have been selected to compose all of the sub-samples. In certain embodiments, processor 13 divides the panelist data into groups wherein each group includes panelists falling within a respective cell including panelists having certain corresponding personal characteristics as indicated by the panelist characteristic data of the panelists in the cell. Processor 13 then selects a predetermined number of panelists from each group in a randomized manner to include in each sub-sample, wherein the predetermined number selected from each group is determined to ensure that each sub-sample fairly represents the composition of the sampled population overall in terms of personal characteristics. In certain other embodiments the sub-samples are not selected in a manner designed to ensure statistically valid sub-samples in cases where statistical validity is not required.

Processor 13 then assigns 31 data gathering times data to each sub-sample representing a respective time period or time periods during which those of the portable research data gathering devices A, B, . . . , N assigned to the members of the sub-sample will be configured to gather research data during one or more monitoring days and stores the data gathering times data in association with data identifying its respective sub-sample in storage 15. For each sub-sample, processor 13 then accesses correspondence data either from database 21 or database 23 that identifies the respective one of the devices A, B, . . . , N assigned to each panelist within a given group and, based on such correspondence data, stores 33 configuration data including the respective data gathering times data for that group in association with each of the devices assigned to panelists within such group. From this stored data, processor 13 then accesses the data gathering times data for each of the devices A, B, . . . , N to be configured and produces a message comprising its respective configuration data including such data gathering times data. Processor 13 then instructs 35 the communications 17 to communicate the message to the respective one of the devices A, B, . . . , N which, upon receipt of such message configures itself to gather research data only during the times prescribed by the data gathering times data in the received message.

In certain embodiments, processor 13 assigns data gathering time periods to each of the devices A, B, . . . , N, and subsequently assigns a respective one of the devices A, B, . . . , N to a panelist within a sub-sample assigned the same data gathering time period or periods as such respective device. In such embodiments, the devices A, B, . . . , N can be configured to gather research data during a predetermined time period or time periods before each such device is assigned to a respective panelist. In the alternative, the devices A, B, . . . , N can be configured after they have been assigned to respective panelists (for example, after the devices A, B, . . . , N have been delivered to their respective panelists and they are either being configured with data gathering time periods, or reconfigured therewith).

In certain embodiments, processor 13 receives data gathered by the devices A, B, . . . , N or data based thereon, via communications 17 or a different input (not shown for purposes of simplicity and clarity), from which processor 13 determines whether the amount and/or quality of the gathered data from each sub-sample is sufficient to satisfy parameters for the research operation as contained in the research operation parameter data. If the processor 13 determines, based on the research operation parameter data, that the data provided by a given sub-sample is not sufficient in quantity and/or quality, it adjusts the membership of the sub-sample by adding and/or deleting panelists to increase the amount of data gathered thereby or the quality thereof, as appropriate. Such adjustment is achieved by reconfiguring selected ones of the devices A, B, . . . , N corresponding to panelists to be added or removed from the sub-sample to cause such devices either to gather data during the time period or time periods assigned to such sub-sample or cease gathering data during such time prior or periods, or else by adding one or more new panelists from a sample pool by providing them with appropriately configured portable research data gathering devices or by reconfiguring devices already in their possession.

In certain embodiments, processor 13 receives data from panel database 21 representing the composition of the various sub-samples in terms of personal characteristics as reflected by their panelist characteristic data and compares it against target composition data contained in the research operation parameter data. If the processor 13 determines, based on the research operation parameter data and the data from panel database 21, that the composition of a given sub-sample has diverged from the target composition data beyond a predetermined tolerance as defined by the research operation parameter data, it adjusts the membership of the sub-sample by adding and/or deleting panelists having appropriate panelist characteristic data to adjust the characteristics of the sub-sample to conform to the target composition data within the predetermined tolerance. Such adjustment is achieved by reconfiguring selected ones of the devices A, B, . . . , N corresponding to panelists to be added or removed from the sub-sample to cause such devices either to gather data during the time period or time periods assigned to such sub-sample or cease gathering data during such time prior or periods, or else by adding one or more new panelists having the appropriate panelist characteristic data from a sample pool by providing them with appropriately configured portable research data gathering devices or by reconfiguring devices already in their possession. In certain embodiments, processor 13 obtains back-out data contained in the research operation parameter data representing forecasted back-outs of panelists from the panel based on the panelist characteristic data, and adds and/or removes panelists from the various sub-samples based on such back-out data to conform the sub-sample to the sampled population. Techniques for adjusting the membership of the sub-samples to maintain such conformance based on back-out data are disclosed in U.S. patent application Ser. No. 10/442,206 filed May 20, 2003, assigned to the assignee of the present application and incorporated herein by reference in its entirety.

In certain embodiments, the process as illustrated in FIG. 1B is modified so that research data gathering time periods are assigned throughout the panel (which may be either statistically valid or not) to gather either uniform or substantially uniform amounts of data throughout the monitoring day, or to gather either greater or lesser amounts of data during selected time periods of the monitoring day. In certain ones of such embodiments, the configuration data is produced so that, those of devices A, B, . . . , N which gather data during each respective time period correspond to a group of panelists having a profile of panelist characteristic data that fairly corresponds to a population from which the plurality of panelists are sampled. While each of the devices A, B, . . . , N only gathers research data during a time period or time periods that total less than the entire monitoring day, collectively the devices A, B, . . . , N gather data throughout the monitoring day. In certain ones of such embodiments, the research data gathering time periods are assigned to achieve uniform data gathering either throughout the panel overall, or within each cell within the panel. It will be appreciated based on the disclosure of the present application that in certain ones of these embodiments, it is unnecessary to form sub-samples of the panel, but rather that the data gathering times data may be assigned to the devices A, B, . . . , N without regard to the panelist characteristic data of the panelists to whom such devices are assigned.

FIG. 1C illustrates certain embodiments of a process for producing the configuration data for the portable research data gathering devices A, B, . . . , N without regard to the panelist characteristic data of the panelists A, B, . . . , N. Processor 13 accesses 37 research operation parameter data from a database (not shown for purposes of simplicity and clarity) which indicates the various time periods during which data is to be gathered pursuant to a research operation within one or more monitoring days thereof, along with the numbers or proportions of the devices A, B, . . . , N to which the various time periods are to be assigned. Processor 13 accesses device identification data from the device database 23 (see FIG. 1A) that identifies each of the devices A, B, . . . , N, and assigns 39 respective data gathering times data to each of the devices A, B, . . . , N so that the numbers or proportions of the devices A, B, . . . , N assigned to the various time periods conforms to the research operation parameter data. Processor 13 then stores the assigned data gathering times data in association with the respective device identification data in storage 15. In certain ones of such embodiments processor 13 selects the device identification data for assignment of the respective data gathering times data in a randomized fashion while in other ones of such embodiments processor 13 selects the device identification data in a non-randomized fashion, such as sequentially or according to some repeating pattern, for this purpose. Where the device identification data has already been assigned to the panelists A, B, . . . , N and the panel has been selected in a randomized manner so that it is statistically valid, assignment of the respective data gathering times data to the devices A, B, . . . , N in a randomized manner will tend to distribute the respective data gathering times data to the devices A, B, . . . , N and the corresponding panelists A, B, . . . , N in a manner that fairly reflects the composition of the population in each of the time periods. Where the device identification data has not already been assigned to the panelists A, B, . . . , N, the respective data gathering times data may be assigned to the devices A, B, . . . , N in either a non-randomized or randomized manner. If the panel is statistically valid, assigning the device identification data to the panelists A, B, . . . , N in a randomized manner will tend to conform each portion of the panel whose devices A, B, . . . , N gather data during each respective time period to the overall characteristics of the population. Where the panel is not statistically valid, the respective data gathering times data may be assigned to the devices A, B, . . . , N in any convenient way, whether or not randomized.

In certain embodiments, the respective data gathering times data is assigned by processor 13 to the device identification data without regard to the panelist characteristic data of the panelists to whom the devices A, B, . . . , N are already assigned. Whether or not the panel itself is statistically valid, when the gathered data is later received from the devices A, B, . . . , N at a processing facility for tabulation, it can then be selected to produce the in-tab data in a way that conforms to the desired distribution of panelist characteristics within each time period of the monitoring day or days. While the data thus gathered is nevertheless useful for preparing media exposure and other types of market research reports, this could result in discarding otherwise valid data for time periods having more monitored data than the desired data distribution requires.

Processor 13 then accesses 41 the stored assigned data gathering times data for each of the devices A, B, . . . , N to be configured and produces a message comprising its respective configuration data including such data gathering times data. Processor 13 then instructs the communications 17 to communicate the message to the respective one of the devices A, B, . . . , N which, upon receipt of such message configures itself to gather research data only during the times prescribed by the data gathering times data in the received message.

FIG. 1D is a functional block diagram illustrating advantageous embodiments of a portable research data gathering device 10 for gathering research data by reading ancillary codes encoded as messages in audio media data. In certain ones of such embodiments, the encoded messages comprise a continuing stream of messages including data useful in audience measurement, commercial verification, royalty calculations and the like. Such data typically includes an identification of a program, commercial, file, song, network, station and/or channel, or otherwise describes some aspect of the media audio data or other data related thereto, so that it characterizes the audio media data. In certain ones of such embodiments, the continuing stream of encoded messages is comprised of symbols arranged time-sequentially in the audio media data.

The device 10 comprises an audio media data input 12 for receiving audio media data that may be encoded with ancillary codes. In certain embodiments, the audio media data input 12 comprises or is included in, either a single device, stationary at a source to be monitored, or multiple devices, stationary at multiple sources to be monitored. In certain embodiments, the audio media data input 12 comprises and/or is included in, a portable device that can be carried by an individual to monitor whatever audio media data the individual is exposed to. In certain embodiments, a PUA comprises the audio media data input.

Where the audio media data is acoustic data, the audio media data input 12 typically would comprise an acoustic transducer, such as a microphone, having an input which receives audio media data in the form of acoustic energy and which serves to transduce the acoustic energy to electrical data. Where audio media data in the form of light energy is monitored, the audio media data input 12 comprises a light-sensitive device, such as a photodiode. In certain embodiments, the audio media data input 12 comprises a magnetic pickup for sensing magnetic fields associated with a speaker, a capacitive pickup for sensing electric fields or an antenna for electromagnetic energy. In still other embodiments, the audio media data input 12 comprises an electrical connection to a monitored device, which may be a television, a radio, a cable converter, a satellite television system, a game playing system, a VCR, a DVD player, a PUA, a portable media player, a hi-fi system, a home theater system, an audio reproduction system, a video reproduction system, a computer, a web appliance, or the like. In still further embodiments, the audio media data input 12 is embodied in monitoring software running on a computer or other reproduction or processing system to gather media data.

Storage 14 stores the received audio media data for subsequent processing. Processor 16 serves to process the received data to read ancillary codes encoded in the audio media data and stores the detected encoded messages in storage 14. For example, it may be desired to store the data produced by processor 16 for later use. Communications 18 coupled with processor 16 serves to communicate data from device 10, for example, for producing reports based on ancillary codes read by processor 16 from audio media data and communicated from device 10. In certain embodiments, a further processor (not shown for purposes of simplicity and clarity) processes audio media data communicated from device 10 either in compressed or uncompressed form, to read ancillary codes therein. In certain embodiments, processor 16 carries out preliminary processing of the audio media data to reduce the processing demands on the further processor which completes processing of the preprocessed data to read ancillary codes therefrom. In certain embodiments, processor 16 serves to read ancillary codes in audio media data using a first process and the further processor further processes the ancillary codes and/or the audio media data gathered by device 10 using a second process that is a modified version of the first process or a different process.

Communications 18 serves further, under the control of processor 14, to communicate with system 11 of FIG. 1 via network 19 to receive a message including configuration data therefrom. Upon receipt of the message, processor 14 is controlled thereby to store data in storage 16 configuring the device 10 for gathering data only during the time period or periods specified by the configuration data included in the received message.

FIG. 2 is a diagram for use in explaining operation of certain embodiments of the system of FIG. 1D. As shown at 20, time-domain audio data is received by the monitoring device 12. Once received, the time-domain audio data, representing the audio signal as it varies over time, is converted by processor, as shown at 22, to frequency-domain audio data, i.e., data representing the audio signal as it varies with frequency. As will be understood by one of ordinary skill in the art, conversion from the time domain to the frequency domain may be accomplished by any one of a given, existing number of techniques comprising, for instance, Fast Fourier Transform (FFT), DCT, wavelet transform, Hadamard transform or other time-to-frequency domain transformation, or else by digital or analog filtering. Processor 16 stores the frequency-domain audio data temporarily in storage 14.

Processor 16 processes the frequency-domain audio data to read an ancillary code therefrom, as shown at 24, and to extract a signature therefrom, i.e., data expressing information inherent to an audio signal, as shown at 26, for use in identifying the audio signal or obtaining other information concerning the audio signal (such as a source or distribution path thereof).

Where audio media includes ancillary codes, suitable decoding techniques are employed to detect the encoded information, such as those disclosed in U.S. Pat. No. 5,450,490 and No. 5,764,763 to Jensen, et al., U.S. Pat. No. 5,579,124 to Aijala, et al., U.S. Pat. Nos. 5,574,962, 5,581,800 and 5,787,334 to Fardeau, et al., U.S. Pat. No. 6,871,180 to Neuhauser, et al., U.S. Pat. No. 6,862,355 to Kolessar, et al., U.S. Pat. No. 6,845,360 to Jensen, et al., U.S. Pat. No. 5,319,735 to Preuss et al., U.S. Pat. No. 5,687,191 to Lee, et al., U.S. Pat. No. 6,175,627 to Petrovich et al., U.S. Pat. No. 5,828,325 to Wolosewicz et al., U.S. Pat. No. 6,154,484 to Lee et al., U.S. Pat. No. 5,945,932 to Smith et al., US 2001/0053190 to Srinivasan, US 2003/0110485 to Lu, et al, U.S. Pat. No. 5,737,025 to Dougherty, et al., US 2004/0170381 to Srinivasan, and WO 06/14362 to Srinivasan, et al., all of which hereby are incorporated by reference herein.

Examples of techniques for encoding ancillary codes in audio, and for reading such codes, are provided in Bender, et al., “Techniques for Data Hiding”, IBM Systems Journal, Vol. 35, Nos. 3 & 4, 1996, which is incorporated herein in its entirety. Bender, et al. disclose a technique for encoding audio termed “phase encoding” in which segments of the audio are transformed to the frequency domain, for example, by a discrete Fourier transform (DFT), so that phase data is produced for each segment. Then the phase data is modified to encode a code symbol, such as one bit. Processing of the phase encoded audio to read the code is carried out by synchronizing with the data sequence, and detecting the phase encoded data using the known values of the segment length, the DFT points and the data interval.

Bender, et al. also describe spread spectrum encoding and decoding, of which multiple embodiments are disclosed in the above-cited Aijala, et at. U.S. Pat. No. 5,579,124.

Still another audio encoding and decoding technique described by Bender, et al. is echo data hiding in which data is embedded in a host audio signal by introducing an echo. Symbol states are represented by the values of the echo delays, and they are read by any appropriate processing that serves to evaluate the lengths and/or presence of the encoded delays.

A further technique, or category of techniques, termed “amplitude modulation” is described in R. Walker, “Audio Watermarking”, BBC Research and Development, 2004. In this category fall techniques that modify the envelope of the audio signal, for example by notching or otherwise modifying brief portions of the signal, or by subjecting the envelope to longer term modifications. Processing the audio to read the code can be achieved by detecting the transitions representing a notch or other modifications, or by accumulation or integration over a time period comparable to the duration of an encoded symbol, or by another suitable technique.

Another category of techniques identified by Walker involves transforming the audio from the time domain to some transform domain, such as a frequency domain, and then encoding by adding data or otherwise modifying the transformed audio. The domain transformation can be carried out by a Fourier, DCT, Hadamard, Wavelet or other transformation, or by digital or analog filtering. Encoding can be achieved by adding a modulated carrier or other data (such as noise, noise-like data or other symbols in the transform domain) or by modifying the transformed audio, such as by notching or altering one or more frequency bands, bins or combinations of bins, or by combining these methods. Still other related techniques modify the frequency distribution of the audio data in the transform domain to encode. Psychoacoustic masking can be employed to render the codes inaudible or to reduce their prominence. Processing to read ancillary codes in audio data encoded by techniques within this category typically involves transforming the encoded audio to the transform domain and detecting the additions or other modifications representing the codes.

A still further category of techniques identified by Walker involves modifying audio data encoded for compression (whether lossy or lossless) or other purpose, such as audio data encoded in an MP3 format or other MPEG audio format, AC-3, DTS, ATRAC, WMA, RealAudio, Ogg Vorbis, APT X100, FLAC, Shorten, Monkey's Audio, or other. Encoding involves modifications to the encoded audio data, such as modifications to coding coefficients and/or to predefined decision thresholds. Processing the audio to read the code is carried out by detecting such modifications using knowledge of predefined audio encoding parameters.

It will be appreciated that various known encoding techniques may be employed, either alone or in combination with the above-described techniques. Such known encoding techniques include, but are not limited to FSK, PSK (such as BPSK), amplitude modulation, frequency modulation and phase modulation.

In certain embodiments, certain encoding techniques, such as those described in U.S. Pat. No. 6,871,180 to Neuhauser, et al., disclose audio encoding techniques that encode audio with one or more continuously repeating messages, each including a number of code symbols following one after the other along a timebase of the audio signal. Each code symbol comprises a plurality of frequency components. In certain embodiments of device 10 that are adapted to read continuously repeating messages, acoustic energy, or, sound, picked up by the monitoring device 12 is continuously monitored to detect the embedded symbols comprising an encoded message. That is, decoding of an encoded message in the audio signal occurs continuously throughout operation of the device 10. In doing so, device 10 performs an FFT by means of processor 14 which is carried out on a continuing basis transforming a time segment of the audio signal to the frequency domain. In certain ones of such embodiments, a segment thereof comprising a one-quarter second duration is transformed to the frequency domain using an FFT, such that the segments overlap by, for example, 40%, 50%, 60%, 70% or 80%. Device 10 separately evaluates for each component of the frequency code symbols in the encoded message whether the received energy comprises either a message or noise first by formulating a quotient comprising an associated energy value of a given frequency bin that would indicate such frequency components relative to a noise level associated with neighboring frequency bins. The noise level is obtained by averaging the energy levels of a predetermined number of frequency ranges neighboring the selected frequency bin being evaluated.

One advantageous technique carries out either or both of code detection and signature extraction remotely from the location where the research data is gathered, as disclosed in US Published Patent Application 2003/0005430 published Jan. 2, 2003 to Ronald S. Kolessar, which is assigned to the assignee of the present application and is hereby incorporated herein by reference in its entirety.

In certain portable research data gathering devices, location tracking or exposure to outdoor advertising is carried out. Suitable techniques for location tracking or monitoring exposure to outdoor advertising are disclosed in U.S. Pat. No. 6,958,710 in the names of Jack K. Zhang, Jack C. Crystal, and James M. Jensen, issued Oct. 25, 2005, and US Published Patent Application 2005/0035857 A1 published Feb. 17, 2005 in the names of Jack K. Zhang, Jack C. Crystal, James M. Jensen and Eugene L. Flanagan III, filed Aug. 13, 2003, all of which are assigned to the assignee of the present application and hereby incorporated by reference herein in their entireties.

Where usage of publications, such as periodicals, books, and magazines, is monitored by portable research data gathering devices, suitable techniques for doing so are employed, such as those disclosed in U.S. patent application Ser. No. 11/084,481 in the names of James M. Jensen, Jack C. Crystal, Alan R. Neuhauser, Jack Zhang, Daniel W. Pugh, Douglas J. Visnius, and Eugene L. Flanagan III, filed Mar. 18, 2005, which is assigned to the assignee of the present application and hereby incorporated by reference herein in its entirety.

In addition to those types of research data mentioned above and the various techniques identified for gathering such types of data, other types of research data are gathered by means of portable research data gathering devices using various techniques. For example, research data relating to consumer purchasing conduct, consumer product return conduct, exposure of consumers to products and presence and/or proximity to commercial establishments may be gathered, and various techniques for doing so may be employed. Suitable techniques for gathering data concerning presence and/or proximity to commercial establishments are disclosed in US Published Patent Application 2005/0200476 A1 published Sep. 15, 2005 in the names of David Patrick Forr, James M. Jensen, and Eugene L. Flanagan III, filed Mar. 15, 2004, and in US Published Patent Application 2005/0243784 A1 published Nov. 3, 2005 in the names of Joan Fitzgerald, Jack Crystal, Alan Neuhauser, James M. Jensen, David Patrick Forr, and Eugene L. Flanagan III, filed Mar. 29, 2005. Suitable techniques for gathering data concerning exposure of consumers to products are disclosed in US Published Patent Application 2005/0203798 A1 published Sep. 15, 2005 in the names of James M. Jensen and Eugene L. Flanagan III, filed Mar. 15, 2004.

Moreover, techniques involving the active participation of the panel members may be implemented by means of portable research data gathering devices used in research operations. For example, surveys may be employed where a panel member is asked questions utilizing the panel member's PUA after recruitment. Thus, it is to be understood that both the exemplary types of research data to be gathered discussed herein and the exemplary manners of gathering research data as discussed herein are illustrative and that other types of research data may be gathered and that other techniques for gathering research data may be employed.

Storage 14 implements one or more accumulators for storage of the quotients associated with varying portions of the audio signal. Storage 14, for instance comprising a first-in/first-out (FIFO) buffer, enables each of the quotients to be continuously, repeatedly accumulated and sorted according to predetermined criteria. Such criteria comprises, optionally, a message length equal to that of the accumulator. Accordingly, where there are multiple messages simultaneously present in the audio, each accumulator serves to accumulate the frequency components of the code symbols in a respective one of the messages. In certain ones of these embodiments, multiple messages are detected as disclosed in U.S. Pat. No. 6,845,360 to Jensen, et al. Accumulation of the messages in this manner comprises an advantage of reducing the influence of noise which factors into the reading of the message.

As explained above, signatures are formed from the same audio data in the frequency domain that is used to decode the encoded messages in the audio.

Suitable techniques for extracting signatures include those disclosed in U.S. Pat. No. 5,612,729 to Ellis, et al. and in U.S. Pat. No. 4,739,398 to Thomas, et al., each of which is assigned to the assignee of the present application and both of which are incorporated herein by reference in their entireties.

Still other suitable techniques are the subject of U.S. Pat. No. 2,662,168 to Scherbatskoy, U.S. Pat. No. 3,919,479 to Moon, et al., U.S. Pat. No. 4,697,209 to Kiewit, et al., U.S. Pat. No. 4,677,466 to Lert, et al., U.S. Pat. No. 5,512,933 to Wheatley, et al., U.S. Pat. No. 4,955,070 to Welsh, et al., U.S. Pat. No. 4,918,730 to Schulze, U.S. Pat. No. 4,843,562 to Kenyon, et al., U.S. Pat. No. 4,450,551 to Kenyon, et al., U.S. Pat. No. 4,230,990 to Lert, et al., U.S. Pat. No. 5,594,934 to Lu, et al., European Published Patent Application EP 0887958 to Bichsel and PCT publication WO91/11062 to Young, et al., all of which are incorporated herein by reference in their entireties.

It is contemplated that device 10 comprises software enabling the extraction of signatures from received audio signals. The software is configured to direct the processor 16 to retain the time at which a particular signature is extracted, and to direct storage thereof in storage 14. The signatures gathered by device 10 are communicated by communications 20 to a processing facility for matching with reference signatures for identifying the broadcast audio signal, or portion thereof.

In certain embodiments, when using data resulting from an FFT performed across a predetermined frequency range, the FFT data from an even number of frequency bands (for example, eight, ten, sixteen or thirty two frequency bands) spanning the predetermined frequency range are used two bands at a time during successive time intervals. FIG. 6 provides an example of how pairs of the bands are selected in these embodiments during successive time intervals where the total number of bands used is equal to ten. The selected bands are indicated by an “X”.

When each band is selected, the energy values of the FFT bins within such band and such time interval are processed to form one bit of the signature. If there are ten FFT's for each interval of the audio signal, for example, the values of all bins of such band within the first five FFT's are summed to form a value “A” and the values of all bins of such band within the last five FFT's are summed to form a value “B”. In the case of a received broadcast audio signal, the value A is formed from portions of the audio signal that were broadcast prior to those used to form the value B or which represent earlier portions of the audio signal relative to its time base.

To form a bit of the signature, the values A and B are compared. If B is greater than A, the bit is assigned a value “1” and if A is greater than or equal to B, the bit is assigned a value of “0”. Thus, during each time interval, two bits of the signature are produced.

Each bit of the signature is a representation of the energy content in the band represented thereby during a predetermined time period, and may be referred to as the “energy slope” thereof. Because any one energy slope is associated with a particular band, as opposed to being associated with a representation of energy content across a group of bands or between certain ones of various bands, the impact of fluctuation in the relative magnitudes of reproduced audio among successive frequency bands is virtually eliminated.

In certain embodiments, signatures are extracted continuously. In such embodiments, information is obtained without a dependency on a triggering, predetermined event, or other type of prompting, and thus through uninterrupted information gathering, the signatures obtained will, necessarily, contain more information. For instance, this additional information is manifested in a signature, or portion thereof, that is formed of information as to how the audio signal changes over time as well as with frequency. This is in contrast to signature extraction occurring only upon prompting caused by a predetermined event and detection thereof, whereby information then obtained is only representative of the audio signal characterized within a certain isolated time frame.

With reference to FIG. 3, which illustrates at least one of certain advantageous embodiments of the system, a PUA 27 is shown which is employed to gather research data. Audio data is received at the microphone 28, which may also comprise a peripheral of the PUA 27 allowing it to be located a remote distance from the remainder thereof should doing so provide added convenience to the user. The audio data is then conditioned and converted from its analog format to digital data, as shown at 30, in a manner understood by one of ordinary skill in the art. A programmable processor 32 coupled with the system then transforms, optionally by FFT or other transform technique including DCT, wavelet transform, Hadamard transform, or else by digital or analog filtering, the digital data to the frequency domain. The PUA 27 further comprises storage, such as a FIFO buffer addressed herein, for cooperation with the processor 32 in a manner well understood by one of ordinary skill in the art, to both decode an ancillary code and extract a signature from the single data set produced by, for example, the FFT. Communications 36 receives data processed by the processor 32 and is coupled thereto for delivery to a remote processing location. PUA 27 further comprises storage 34 for retention of information not immediately transmitted to communications 36.

Communications 36 serves further, under the control of processor 32, to communicate with system 11 of FIG. 1 via network 19 to receive a message including configuration data therefrom. Upon receipt of the message, processor 32 is controlled thereby to store data in storage 34 configuring the PUA 27 for gathering data only during the time period or periods specified by the configuration data included in the received message.

With reference to FIGS. 4 and 4A, there is illustrated a block diagram of a cellular telephone 38 modified to carry out a research operation. The cellular telephone 38 comprises a processor 40 operative to exercise overall control and to process audio and other data for transmission or reception. Communications 50 is coupled to the processor 40 and is operative to establish and maintain a two-way wireless communication link with a respective cell of a cellular telephone network. In certain embodiments, processor 40 is operative to execute applications apart from or in conjunction with the conduct of cellular telephone communications, such as applications serving to download audio and/or video data to be reproduced by the cellular telephone, e-mail clients and applications enabling the user to play games using the cellular telephone. In certain embodiments, processor 40 comprises two or more processing devices, such as a first processing device (such as a digital signal processor) that processes audio, and a second processing device that exercises overall control over operation of the cellular telephone. In certain embodiments, processor 40 comprises a single processing device. In certain embodiments, some or all of the functions of processor are implemented by hardwired circuitry.

Cellular telephone 38 further comprises storage 60 coupled with processor 40 and operative to store data as needed. In certain embodiments, storage 60 comprises a single storage device, while in others it comprises multiple storage devices. In certain embodiments, a single device implements certain functions of both processor 40 and storage 60.

In addition, cellular telephone 38 comprises a microphone 70 coupled with processor 40 and serving to transduce the user's voice to an electrical signal which it supplies to processor 40 for encoding, and a speaker and/or earphone coupled with processor 40 to transduce received audio from processor 40 to an acoustic output to be heard by the user. Cellular telephone 38 also includes a user input 80 coupled with processor 40, such as a keypad, to enter telephone numbers and other control data, as well as a display 90 coupled with processor 40 to provide data visually to the user under the control of processor 40.

In certain embodiments, cellular telephone 38 provides additional functions and/or comprises additional elements. In certain ones of such embodiments, the cellular telephone 38 provides e-mail, text messaging and/or web access through its wireless communications capabilities, providing access to media and other content. For example, Internet access via cellular telephone 38 enables access to video and/or audio content that can be reproduced by the cellular telephone 38 for the user, such as songs, video on demand, video clips and streaming media. In certain embodiments, storage 60 stores software providing audio and/or video downloading and reproducing functionality, such as iPod® software, enabling the user to reproduce audio and/or video content downloaded from a source, such as a personal computer via communications 50 or through direct Internet access via communications 50.

To enable cellular telephone 38 to gather research data, namely, data indicating exposure to audio such as programs, music and advertisements, research software is installed therein to control processor 40 to gather such data and communicate it via communications 50 to a research organization. The research software in certain embodiments also controls processor 40 to store the data for subsequent communication.

Communications 50 under the control of processor 40, serves to communicate with system 11 of FIG. 1 via network 19 to receive a message including configuration data therefrom. Upon receipt of the message, processor 40 is controlled thereby to store data in storage 60 configuring the cellular telephone 38 for gathering data only during the time period or periods specified by the configuration data included in the received message.

The research software controls the processor 40 to transduce the time-domain audio data produced by microphone 100 to read ancillary codes from the frequency domain data using one or more of the known techniques identified hereinabove, and then to store and/or communicate the codes that have been read for use as research data indicating encoded audio to which the user was exposed. The research software also controls the processor 40 to extract signatures from the frequency domain data using one or more of the known techniques identified hereinabove, and then to store and/or communicate the extracted signature data for use as research data which is then matched with reference signatures representing known audio to detect the audio to which the user was exposed. In certain embodiments, the research software controls the processor 40 to store samples of the transduced audio, either in compressed or uncompressed form for subsequent processing to read ancillary codes therein and to extract signatures therefrom after transformation to the frequency domain. In certain embodiments, the research software is operative both to read codes and extract signatures from the audio data, and selectively (a) both reads such codes and extracts such signatures from certain portions of the audio data and (b) either reads codes or extracts codes from other portions of the audio data.

Where the cellular telephone 38 possesses functionality to download and/or reproduce presentation data, in certain embodiments, research data concerning the usage and/or exposure to such presentation data as well as audio data received acoustically by microphone 100, is gathered by cellular telephone 38 in accordance with the technique illustrated by the functional block diagram of FIG. 4A. Storage 60 of FIG. 4 implements an audio buffer 110 for audio data gathered with the use of microphone 100. In certain ones of these embodiments storage 60 implements a buffer 130 for presentation data downloaded and/or reproduced by cellular telephone 38 to which the user is exposed via speaker and/or earphone 70 or display 90, or by means of a device coupled with cellular telephone 38 to receive the data therefrom to present it to a user. In some of such embodiments, the reproduced data is obtained from downloaded data, such as songs, web pages or audio/video data (e.g., movies, television programs, video clips). In some of such embodiments, the reproduced data is provided from a device such as a broadcast or satellite radio receiver of the cellular telephone 38 (not shown for purposes of simplicity and clarity). In certain ones of these embodiments storage 60 implements a buffer 130 for metadata of presentation data reproduced by cellular telephone 38 to which the user is exposed via speaker and/or earphone 70 or display 90, or by means of a device coupled with cellular telephone 38 to receive the data therefrom to present it to a user. Such metadata can be, for example, a URL from which the presentation data was obtained, channel tuning data, program identification data, an identification of a prerecorded file from which the data was reproduced, or any data that identifies and/or characterizes the presentation data, or a source thereof. Where buffer 130 stores audio data, buffers 110 and 130 store their audio data (either in the time domain or the frequency domain) independently of one another. Where buffer 130 stores metadata of audio data, buffer 110 stores its audio data (either in the time domain or the frequency domain) and buffer 130 stores its metadata, each independently of the other.

Processor 40 separately produces research data 120 from the contents of each of buffers 110 and 130 which it stores in storage 60. In certain ones of these embodiments, one or both of buffers 110 and 130 is/are implemented as circular buffers storing a predetermined amount of time-domain audio data representing a most recent time interval thereof as received by microphone 100 and/or reproduced by speaker and/or earphone 70, or downloaded by cellular telephone 38 for reproduction by a different device coupled with cellular telephone 38. Processor 40 extracts signatures and/or decodes ancillary codes in the buffered audio data to produce research data 120 by converting the time-domain audio data to frequency-domain audio data and processing the frequency-domain audio data for reading an ancillary code therefrom and/or extracting a signature therefrom. Where metadata is received in buffer 130, in certain embodiments the metadata is used, in whole or in part, as research data, or processed to produce research data. The research data is thus gathered representing exposure to and/or usage of audio data by the user where audio data is received in acoustic form by the cellular telephone 38 and where presentation data is received in non-acoustic form (for example, as a cellular telephone communication, as an electrical signal via a cable from a personal computer or other device, as a broadcast or satellite signal or otherwise).

With reference again to FIG. 4, in certain embodiments, the cellular telephone 38 comprises a research data source 42 coupled by a wired or wireless coupling with processor 40 for use in gathering further or alternative research data to be communicated to a research organization. In certain ones of these embodiments, the research data source 42 comprises a location data producing device or function providing data indicating a location of the cellular telephone 38. Various devices appropriate for use as the research data source 42 include a satellite location signal receiver, a terrestrial location signal receiver, a wireless networking device that receives location data from a network, an inertial location monitoring device and a location data producing service provided by a cellular telephone service provider. In certain embodiments, research data source 42 comprises a device or function for monitoring exposure to print media, for determining whether the user is at home or out of home, for monitoring exposure to products, exposure to displays (such as outdoor advertising), presence within or near commercial establishments, or for gathering research data (such as consumer attitude, preference or opinion data) through the administration of a survey to the user of the cellular telephone 38. In certain embodiments, research data source 42 comprises one or more devices for receiving, sensing or detecting data useful in implementing one or more of the foregoing functions, other research data gathering functions and/or for producing data ancillary to functions of gathering, storing and/or communicating research data, such as data indicating whether the panelist has complied with predetermined rules governing the activity or an extent of such compliance. Such devices include, but are not limited to, motion detectors, accelerometers, temperature detectors, proximity detectors, satellite positioning signal receivers, RFID readers, RF receivers, wireless networking transceivers, wireless device coupling transceivers, pressure detectors, deformation detectors, electric field sensors, magnetic field sensors, optical sensors, electrodes, and the like.

With reference to FIG. 5, there is illustrated a personal digital assistant (PDA) 200 configured to gather research data. The PDA 200 comprises a processor 210 operative to exercise overall control and to process data for, among other purposes, transmission or reception by the PDA 200. Communications 220 is coupled to the processor 210 and is operative under the control of processor 210 to perform those functions required for establishing and maintaining two-way communications over a network (not shown for purposes of simplicity and clarity).

In certain embodiments, processor 210 comprises two or more processing. devices, such as a first processing device that controls overall operation of the PDA 200 and a second processing device that performs certain more specific operations such as digital signal processing. In certain embodiments, processor 210 employs a single processing device. In certain embodiments, some or all of the functions of processor 210 are implemented by hardwired circuitry.

PDA 200 further comprises storage 230 coupled with processor 210 and operative to store software that runs on processor 210, as well as temporary data as needed. In certain embodiments, storage 230 comprises a single storage device, while in others it comprises multiple storage devices. In certain embodiments, a single device implements certain functions of both processor 210 and storage 230.

PDA 200 also includes a user input 240 coupled with processor 210, such as a keypad, to enter commands and data, as well as a display 250 coupled with processor 210 to provide data visually to the user under the control of processor 210.

In certain embodiments, the PDA 200 provides additional functions and/or comprises additional elements. In certain embodiments, PDA 200 provides cellular telephone functionality, and comprises a microphone and audio output (not shown for purposes of simplicity and clarity), as well as an ability of communications 220 to communicate wirelessly with a cell of a cellular telephone network, to enable its operation as a cellular telephone. Where PDA 200 possesses cellular telephone functionality, in certain embodiments PDA 200 is employed to gather, store and/or communicate research data in the same manner as cellular telephone 38 (such as by storing appropriate research software in storage to run on processor), and communicates with device 10 in the same manner to set up, promote, operate, maintain and/or terminate a research operation using PDA 200.

In certain embodiments, communications 220 of PDA 200 provides wireless communications via Bluetooth protocol, ZigBee™ protocol, wireless LAN protocol, infrared data link, inductive link or the like, to a network, network host or other device, and/or through a cable to such a network, network host or other device. In such embodiments, PDA 200 is employed to gather, store and/or communicate research data in the same manner as cellular telephone 38 (such as by storing appropriate research software in storage to run on processor), and communicates with device 10 in the same manner (either through a wireless link or through a connection, such as a cable) to set up, promote, operate, maintain and/or terminate a research operation using PDA 200.

Communications 220 under the control of processor 210, serves to communicate with system 11 of FIG. 1 via network 19 to receive a message including configuration data therefrom. Upon receipt of the message, processor 210 is controlled thereby to store data in storage 230 configuring the PDA 200 for gathering research data only during the time period or periods specified by the configuration data included in the received message.

In certain embodiments, the PDA 200 comprises a research data source 260 coupled by a wired or wireless coupling with processor 210 for use in gathering further or alternative research data to be communicated to a research organization. In certain ones of these embodiments, the research data source 260 comprises a location data producing device or function providing data indicating a location of the cellular telephone PDA 200. Various devices appropriate for use as source include a satellite location signal receiver, a terrestrial location signal receiver, a wireless networking device that receives location data from a network, an inertial location monitoring device and a location data producing service provided by a cellular telephone service provider. In certain ones of these embodiments, research data source 260 comprises a device or function for monitoring exposure to print media, for determining whether the user is at home or out of home, for monitoring exposure to products, exposure to displays (such as outdoor advertising), presence within or near commercial establishments, or for gathering research data (such as consumer attitude, preference or opinion data) through the administration of a survey to the user of the PDA 200. In certain ones of these embodiments, research data source comprises one or more devices for receiving, sensing or detecting data useful in implementing one or more of the foregoing functions, other research data gathering functions and/or for producing data ancillary to functions of gathering, storing and/or communicating research data, such as data indicating whether the panelist has complied with predetermined rules governing the activity or an extent of such compliance. Such devices include, but are not limited to, motion detectors, accelerometers, temperature detectors, proximity detectors, satellite positioning signal receivers, RFID readers, RF receivers, wireless networking transceivers, wireless device coupling transceivers, pressure detectors, deformation detectors, electric field sensors, magnetic field sensors, optical sensors, electrodes, and the like.

By configuring the portable research data gathering devices to gather data only during a time period or periods having a total duration less than that of a monitoring day, it is possible to substantially reduce the likelihood that data gathering activities of the devices will either unduly draw down their onboard power sources, or undesirably interfere with other functions provided by the devices. For example, where data gathering functions are implemented in PUA'S, such as cellular telephones or PDA'S, it is possible to substantially reduce the demands of the data gathering functions on the device's power supply, and processing, storage and communications capabilities. Where data gathering functions are implemented in dedicated data gathering devices, such as PPM™ decoders, it is possible to extend their duration of operation between charging, reduce required memory capacity and/or communications demands, reduce the size and weight of the device and/or enable the implementation of additional data gathering functions in existing devices.

Although various embodiments have been described with reference to a particular arrangement of parts, features and the like, these are not intended to exhaust all possible arrangements or features, and indeed many other embodiments, modifications and variations will be ascertainable to those of skill in the art.

What is claimed is:

1. A method carried out in a research operation in which each of a plurality of panelists carries a portable research data gathering device, comprising selecting respective ones of the portable research data gathering devices and configuring each of the selected portable research data gathering devices to gather research data only during a time period or time periods of a monitoring day of the research operation having a total duration which is less than the duration of the monitoring day.

2. The method of claim 1, wherein the selected portable research data gathering devices are configured so that, collectively, the selected portable research data gathering devices gather research data throughout the monitoring day.

3. The method of claim 1, wherein configuring the portable research data gathering devices is carried out such that, portable research data gathering devices which gather data during each respective time period correspond to a group of panelists having a predetermined profile of panelist characteristics so that the group of panelists fairly represents a population from which the plurality of panelists are selected.

4. A system for setting up and/or managing a research operation in which each of a plurality of panelists carries a portable research data gathering device, comprising a processor operative to select respective ones of the portable research data gathering devices, the processor being operative to configure each of the selected portable research data gathering devices to gather research data only during a time period or time periods of a monitoring day of the research operation having a total duration which is less than the duration of the monitoring day.

5. The system of claim 4, wherein the processor is operative to configure the selected portable research data gathering devices so that, collectively, the selected portable research data gathering devices gather research data throughout the monitoring day.

6. The system of claim 4, wherein the processor is operative to configure the selected portable research data gathering devices so that, portable research data gathering devices which gather data during each respective time period correspond to a group of panelists having a predetermined profile of panelist characteristics so that the group of panelists fairly represents a population from which the plurality of panelists are selected.

7. A system for gathering research data in a research operation, comprising a plurality of portable research data gathering devices each capable of being carried by a panelist, each of the portable research data gathering devices being configured to gather research data only during a time period or time periods of a monitoring day of the research operation having a total duration which is less than the duration of the monitoring day.

8. The system of claim 7, wherein the plurality of portable research data gathering devices are configured so that, collectively, they gather research data throughout the monitoring day.

9. The system of claim 7, wherein the plurality of portable research data gathering devices are configured so that, portable research data gathering devices which gather data during each respective time period correspond to a group of panelists having a predetermined profile of panelist characteristics so that the group of panelists fairly represents a population from which the plurality of panelists are selected.

10. A method for gathering research data in a research operation, comprising gathering research data using a plurality of portable research devices each carried by a respective one of a plurality of panelists, each of the research devices being configured to gather research data only during a time period or time periods of a monitoring day of the research operation having a total duration which is less than the duration of the monitoring day.

11. The method of claim 10, wherein the plurality of portable research devices are configured so that, collectively, the plurality of portable research data gathering devices gather research data throughout the monitoring day.

12. The method of claim 10, wherein the plurality of portable research devices are configured so that, portable research data gathering devices which gather data during each respective time period correspond to a group of panelists having a predetermined profile of panelist characteristics so that the group of panelists fairly represents a population from which the plurality of panelists are selected.
